(19) United States
(12) Patent Application Publication
(10) Pub. No.: US 2013/0061683 A1
(43) Pub. Date: Mar. 14, 2013

(54) SYSTEMS AND METHODS FOR PERFORMING STRUCTURAL TESTS ON WIND TURBINE BLADES

(71) Applicants: Myles L. Baker, Long Beach, CA (US); Cory P. Arendt, Huntington Beach, CA (US); Bernard G. Madrid, Huntington Beach, CA (US); Sheldon Vilhauer, Carson, CA (US)

(72) Inventors: Myles L. Baker, Long Beach, CA (US); Cory P. Arendt, Huntington Beach, CA (US); Bernard G. Madrid, Huntington Beach, CA (US); Sheldon Vilhauer, Carson, CA (US)

(73) Assignee: Modulr Wind Energy, Inc., Huntington Beach, CA (US)

(21) Appl. No.: 13/549,948

(22) Filed: Jul. 16, 2012

Related U.S. Application Data
(63) Continuation of application No. PCT/US2011/021770, filed on Jan. 19, 2011.
(60) Provisional application No. 61/296,444, filed on Jan. 19, 2010.

(51) Int. Cl. F03D 11/04; G01M 13/00

(52) U.S. Cl. 73/834; 73/856; 73/826

(57) ABSTRACT

Systems and methods for performing structural tests on wind turbine blades are disclosed herein. A system in accordance with a particular embodiment includes a test stand positioned to carry a test article that includes at least a portion of a wind turbine blade. The system can further include first and second reaction anchors movably positioned relative to the test stand. A first generally horizontal force link is attached to the first reaction anchor and coupleable to the test article to apply a first horizontal load to the test article. A second generally horizontal force link is attached to the second reaction anchor and is coupleable to the test article to apply a second horizontal load to the test article. The test stand can be positioned to apply a test stand force to the test article equal and opposite to the sum of the first and second horizontal loads.

### RELATED APPLICATIONS

The present application is a continuation application of International Patent Application No. PCT/US2011/021770, filed Jan. 19, 2011, which claims priority to U.S. Provisional Application No. 61/296,444 filed Jan. 19, 2010 and each of which is incorporated herein in its entirety by reference.

### TECHNICAL FIELD

The present disclosure is directed generally to systems and methods for performing structural tests on wind turbine blades and/or segments of wind turbine blades.

### BACKGROUND

Structural testing has been used for many years to simulate the operating conditions experienced by structural components, in an effort to demonstrate the longevity and/or safety of such components. Structural testing has accordingly been used to test components for cars, aircraft, ships, and related heavy machinery. More recently, structural testing has been used to demonstrate the safety and strength characteristics of wind turbine blades. Wind turbine blades have become dramatically larger over the last several years as manufacturers strive to extract as much energy as possible with a given wind turbine. Accordingly, the equipment required to test the wind turbine blades has become progressively larger, more expensive, and more cumbersome to use. As a result, there are now only a limited number of facilities with the equipment and the capacity to test new wind turbine blades. Accordingly, there exists a need for more cost-effective, user-friendly and decentralized testing methods and systems.

### BRIEF DESCRIPTION OF THE DRAWINGS

FIG. 1 is a partially schematic, isometric illustration of a system set up to test a wind turbine blade segment in accordance with an embodiment of the disclosure.

FIG. 2 is a partially schematic, top plan view of an embodiment of the system shown in FIG. 1.

FIG. 3 is a top plan view of an embodiment of the system shown in FIGS. 1 and 2, set up to test an entire wind turbine blade in accordance with another embodiment of the disclosure.

FIG. 4 is a partially schematic, isometric illustration of an embodiment of the system shown in FIG. 3.

FIG. 5 is a simplified block diagram illustrating features of the foregoing systems.

FIGS. 6A-6D illustrate representative attachment techniques for use with systems in accordance with particular embodiments of the disclosure.

FIGS. 7A-7B illustrate aspects of systems configured to perform fatigue tests on wind turbine blades and/or wind turbine blade segments in accordance with particular embodiments of the disclosure.

### DETAILED DESCRIPTION

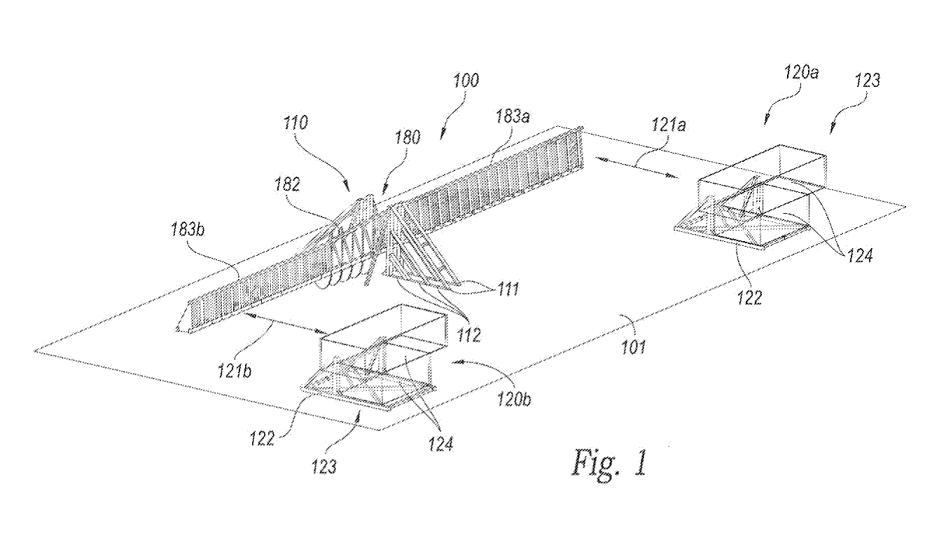

Specific details of several embodiments of systems and methods for performing structural tests on wind turbine blades and blade segments are described below with reference to particular test fixtures and associated procedures. In other embodiments, the fixtures and associated methods can have other arrangements. Several details describing structures and processes that are well-known and often associated with structural testing fixtures, but that may unnecessarily obscure some significant aspects of the disclosure, are not set forth in the following description for purposes of clarity. Moreover, although the following disclosure sets forth several embodiments of different aspects of the invention, several other embodiments can have different configurations or different components than those described in this section. As such, the present disclosure and associated technology can encompass other embodiments with additional elements and/or other embodiments without several of the elements described below with reference to FIGS. 1-7B.

Several embodiments of the disclosure described below may take the form of computer-executable instructions, including routines executed by a programmable computer and/or controller. Those skilled in the relevant art will appreciate that the invention can be practiced on computer/controller systems other than those shown and described below. The invention can be embodied in a special-purpose computer/controller or data processor that is specifically programmed, configured or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable computer consumer electronics, network computers, minicomputers and the like). Information handled by these computers can be presented at any suitable display medium, including a CRT display or LCD.

Aspects of the disclosure can also be practiced in distributed environments, where tasks or modules are performed by remote processing devices that are linked through a communications network. In a distributed computing environment, the program modules or subroutines may be located in local and remote memory storage devices. Aspects of the disclosure described below may be stored or distributed on computer-readable media, including magnetic or optically readable or removable computer disks, as well as distributed electronically over networks. Data structures and transmissions of data particular to aspects of the disclosure are also encompassed within the scope of the present disclosure.

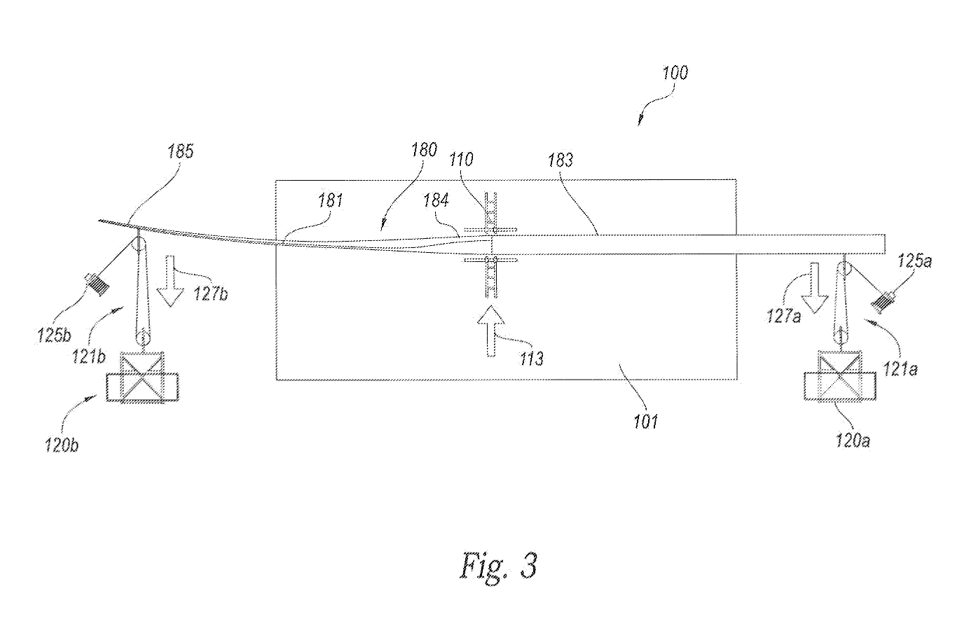

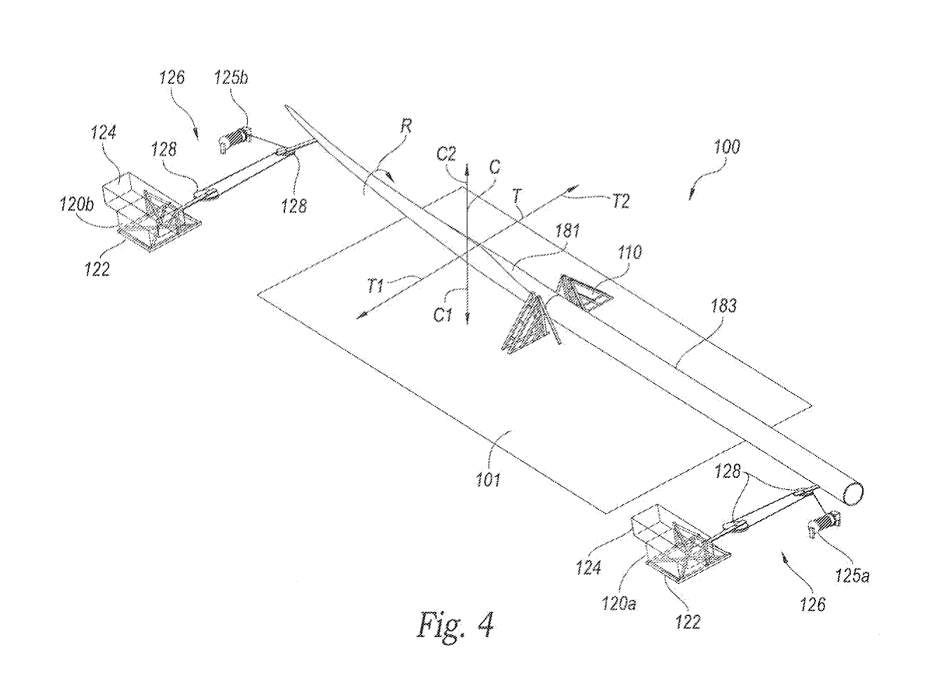

FIG. 1 is a partially schematic, isometric illustration of a test system 100 set up to perform structural tests on a test article 180. In a particular aspect of this embodiment, the test article 180 includes a wind turbine blade segment 182, and in other embodiments, the test system 100 can be used to test other articles, including entire wind turbine blades, as described later with respect to FIGS. 3 and 4. For purposes of illustration, the wind turbine blade segment 182 is shown in FIG. 1 as a series of chordwise-extending ribs and spars, without an outer skin. The blade segment 182 can be tested with or without an outer skin attached. In any of these embodiments, the test system 100 can include a test stand 110 that carries the test article 180 and is firmly or rigidly attached to a base 101 (e.g., a concrete pad). The test system 100 can further include two reaction anchors 120, shown as a first reaction anchor 120a and a second reaction anchor 120b that are movable relative to the test stand 110. The first reaction anchor 120a is operatively coupled to the test article 180 via a first force link 121a and the second reaction anchor 120b is operatively coupled to the test article 180 via a second force link 121b. Accordingly, the first and second force links 121a, 121b can apply a horizontal force in one direction (e.g., generally from left to right as shown in FIG. 1), while the test stand 110 provides an equal and opposite force on the test article 180, allowing the test article 180 to undergo bending in a generally horizontal plane. As will be described further in the following discussion, this arrangement can provide significant benefits over existing test fixture arrangements, including greater configurability, lower cost, and wider applicability.

In a particular aspect of an embodiment shown in FIG. 1, the test stand 110 includes laterally extending stand rails 111, which are attached to the base 101 via stand anchors 112 (e.g., bolts). The base 101 can include a concrete pad, for example, an eight inch thick concrete pad. The stand rails 111 can be attached to the base 101 with a multitude of stand anchors 112, and can extend for a significant lateral distance away from the test article 180. An advantage of this arrangement is that it distributes the force transmitted by the test stand 110 to the base 101 over a wide area. As a result, the base 101, though it is certainly robust, need not be a bulky as existing test fixtures that rely on cantilevering the test article 180.

In another aspect of an embodiment shown in FIG. 1, the test article 180 is relatively small compared to the test stand 110 and the reaction anchors 120. Accordingly, the system 100 can include a first extender 183a releasably attached to one end of the test article 180 and second extender 183b releasably attached to the opposite end of the test article 180. The first and second force links 121a, 121b are accordingly attached to the first extender 183a and the second extender 183b, respectively, to apply bending loads to the test article 180.

Unlike the test stand 110, the reaction anchors 120 can be movable relative to the base 101. For example, each of the reaction anchors 120 can include a sled 122 that can be readily moved over the surface of the base 101, and one or more weights 123 that releasably secure the sled 122 to the base 101 at any location. In a particular embodiment, the weights 123 can include one or more water tanks 124, each of which can be filled with water to react the lateral force provided by the corresponding force link 121a, 121b. After testing, the water tanks 124 can be emptied (e.g., into a temporary storage tank) and the sled 122 can be moved to another position on the base 101 where the tanks 124 are refilled. At the new position, the sled 122 can apply a different loading to the test article 180, and/or to accommodate a test article 180 having dimensions different than those shown in FIG. 1. Accordingly, the system 100 can be readily reconfigured to accommodate test articles having a wide range of dimensions, without incurring a significant cost. In a particular aspect of an embodiment shown in FIG. 1, each of the reaction anchors 120 can be moved in any direction over the base 101 (e.g., via a forklift or similar device) so as to be located at any position on the base 101 relative to the test stand 110. In other embodiments, the reaction anchors 120 can be moved off the base 101. In still further embodiments, the motion of the reaction anchors 120 can be restricted. For example, the reaction anchors 120 can be placed on one or more sets of rails so as to move in a constrained fashion. However, in many instances, it is expected that the ability to move the reaction anchors 120 to any arbitrary position on or off the base 101 can provide for greater functionality.

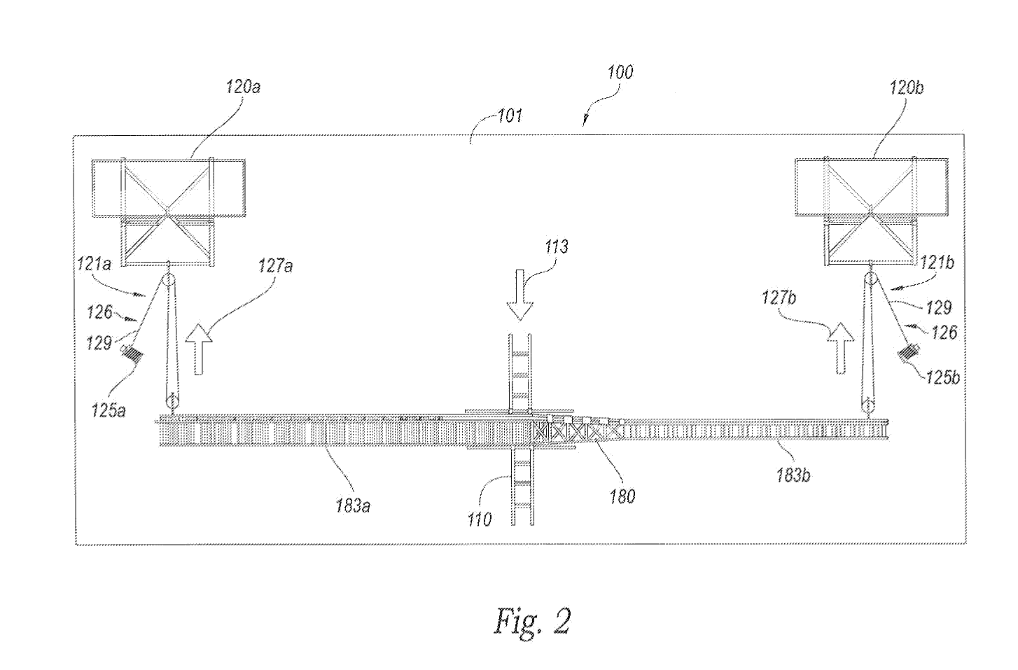

FIG. 2 is a partially schematic, top plan view of an embodiment of the system 100 shown in FIG. 1. As shown in FIG. 2, each of the first and second force links 121a, 121b can include a corresponding cable 129 threaded through a pulley arrangement 126 (e.g., a block and tackle) which is illustrated schematically, and attached to a corresponding winch 125, shown as a first winch 125a and a second winch 125b. When the first and second winches 125a, 125b are activated, the first winch 125a can apply a first applied force 127a to the first extender 183a (and therefore the test article 180), while the second winch 125b applies a second applied force 127b to the second extender 183b (and therefore the test article 180). The actions of the first winch 125a and the second winch 125b can be coordinated so as to avoid skewing or providing an unbalanced load to the test article 180. The test stand 110 provides a test stand force 113 that is generally equal to the sum of the first and second applied forces 127a, 127b and is generally in the opposite direction of the first and second applied forces 127a, 127b to balance the loads applied to the test article 180. In a particular aspect of this embodiment, the winches 125a, 125b can be spaced apart from the corresponding reaction anchors 120a, 120b. In other embodiments, the winches 125a, 125b (or other active loading devices) can be carried by the corresponding reaction anchor.

In another embodiment, the system 100 can operate without one of the winches 125, 125b. For example, the second winch 125b can be replaced with a static or passive connection (e.g., a cable) between the second extender 183b and the second reaction anchor 120b. Accordingly the first winch 125a can apply load to the test article 180 to bend the test article 180 while the second extender 183b undergoes limited or no deflection. This arrangement can be simpler than one that includes two winches or other active devices, provided the lack of deflection at the second extender 183b is properly accounted for when analyzing the forces applied to and deflections experienced by the test article 180.

FIG. 3 is a partially schematic, plan view of the test system 100 after it has been reconfigured to apply loads to a test article 180 that includes a full length, full scale wind turbine blade 181. The blade 181 can have a length of approximately 50 meters in one embodiment, and greater or lesser lengths in other embodiments. The test stand 110 remains in its fixed position relative to the base 101, while the first and second anchors 120a, 120b have been moved further away from the test stand 110 to accommodate the increased length of the blade 181 relative to the blade segment 182 described above with reference to FIGS. 1 and 2. The blade 181 includes a hub region 184 and a tip region 185 that is positioned outwardly from the hub region 184 in a longitudinal or spanwise direction. The hub region 184 is carried by the test stand 110, and an extender 183 has been attached to the blade 181 at the hub region 184. Accordingly, the extender 183 provides a lever arm that facilitates balancing the bending load applied to the tip region 185 during testing.

In a particular aspect of an embodiment shown FIG. 3, the first and second reaction anchors 120a, 120b have been moved entirely off the base 101 to accommodate the length of the blade 181 and the extender 183. Accordingly, the base 101 need only provide support for the test stand 110 and not the reaction anchors 120a, 120b so long as the reaction anchors 120a, 120b can be stably positioned relative to the test article 180 with sufficient accuracy. Because the first and second reaction anchors 120a, 120b, have been repositioned relative to the test stand 110, the corresponding first and second winches 125a, 125b are also repositioned. During operation, the first winch 125a can be activated to provide the first applied force 127a, the second winch 125b can be operated to provide the second applied force 127b, and the test stand 110 can provide an equal and opposite test stand force 113 to balance the first and second applied forces 127a, 127b.

FIG. 4 is a partially schematic, isometric illustration of an embodiment of the test system 100 shown in FIG. 3. As shown in FIG. 4, each of the pulley arrangements 126 can include one or more pulleys 128 (two are shown in FIG. 4) to provide a mechanical advantage for the corresponding first and second winches 125a, 125b. When activated, the winches 125a, 125b apply a force along the thickness axis T of the wind turbine blade 181 in a first direction T1. After testing in the first direction T1 is complete, the first reaction anchor 120a, the second reaction anchor 120b, and the associated winches and pulley arrangements can be relocated to the opposite side of the wind turbine blade 181 and reconnected to the blade 181 and the extender 183 to apply forces along the thickness axis T but in a second direction T2 opposite the first direction T1. As discussed above, the reaction anchors 120a, 120b can be moved by emptying the water tanks 124, lifting or sliding the sleds 122 and refilling the water tanks 124 when the sleds 122 are in the correct position. Accordingly, the test system 100 can be readily reconfigured to apply forces in two directions along the same axis.

The test system 100 can also be reconfigured to apply loads along more than one axis. For example, the wind turbine blade 181 and the extender 183 can be rotated as a unit about the longitudinal axis of the blade 181 (e.g., by 90°) as shown by arrow R, to align the chordwise axis C of the wind turbine blade 181 in a generally horizontal direction. With the wind turbine blade 181 in this orientation, the first and second reaction anchors 120a, 120b can be used to apply chordwise bending loads to the wind turbine blade 181 in a first direction C1. In a manner similar to that discussed above, the reaction anchors 120a, 120b can then be repositioned to the opposite side of the wind turbine blade 181 to apply chordwise loads in a second chordwise direction C2. The wind turbine blade 181 and the extender 183 can be rotated to angles other than 90° depending on the particular test regimen. In one embodiment, the extender 183 rotates with the wind turbine blade 181 to the new orientation, assuming it is configured to withstand loads in the new direction. In another embodiment, the extender 183 is disconnected from the wind turbine blade 181 prior to rotating the blade 181, then re-attached after the blade 181 is rotated. In this way, the extender 183 can have the same orientation before and after the blade 181 is rotated, and can be tailored to preferentially withstand loads in that orientation.

In still another embodiment, the test system 100 can be arranged to impart a vertical load to the wind turbine blade 181. For example, the wind turbine blade 181 can be elevated at the test stand 110 and then tipped or canted so that the free end of the extender 183 is at or near the surface of the pad 101 and the free tip of the wind turbine blade 181 is further elevated above the pad 101. If space permits, the second reaction anchor 120b and/or the second winch 125b can be placed under the tip of the wind turbine blade 181 so as to pull directly downwardly on the blade 181. In another aspect of this embodiment (e.g., if space does not allow the foregoing arrangement), the winch cable can be routed through a pulley (not shown in FIG. 4) located directly beneath the blade 181. The first reaction anchor 120a can be positioned directly on top of the free end of the extender 183, or it can be otherwise positioned to secure the extender 183. The first winch 125a can be eliminated in one aspect of this embodiment. In particular embodiments, the first reaction anchor 120a can have a sled-like arrangement, as shown in FIG. 4, with the sled shaped to fit over the end of the extender 183. In other embodiments, the first reaction anchor 120a can have other movable configurations, for example, one or more sand bags or other weights placed directly on the extender 183.

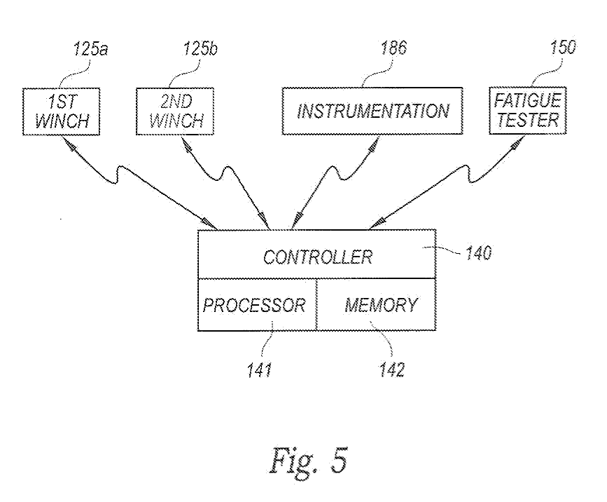

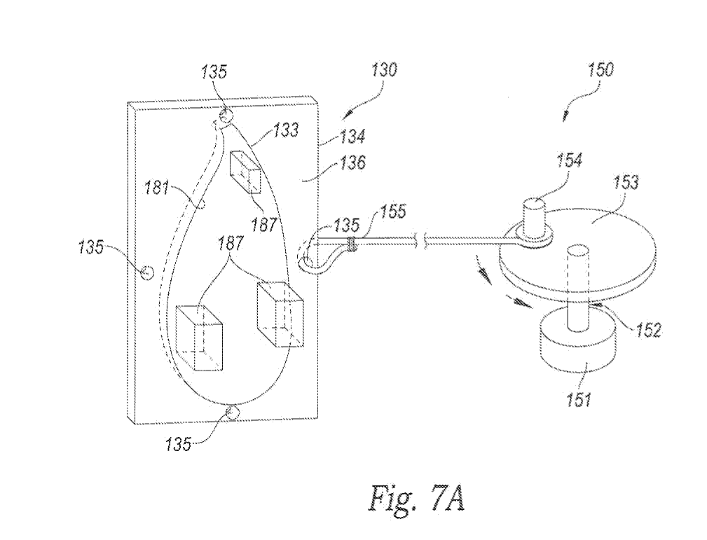

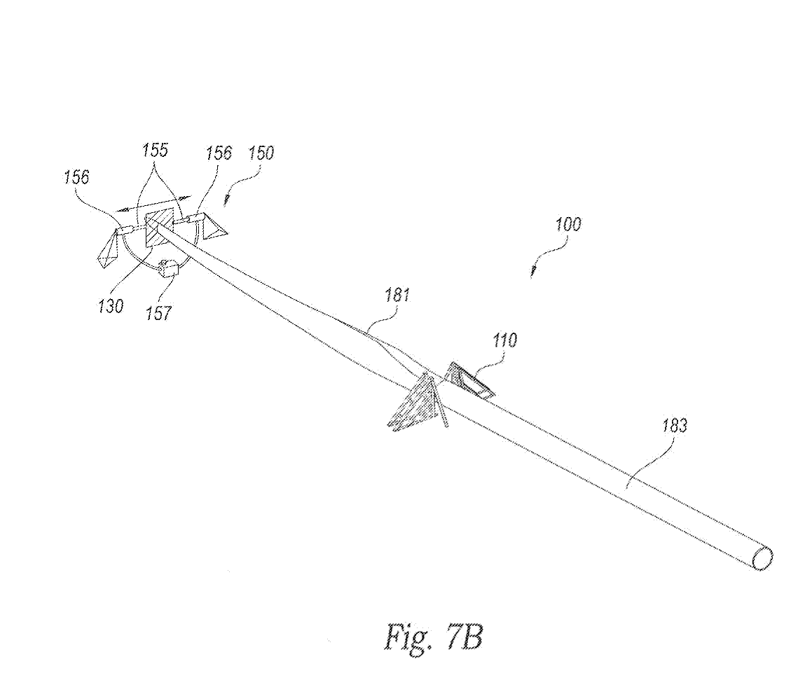

FIG. 5 is a schematic block diagram illustrating a controller 140 operatively coupled to the first winch 125a, the second winch 125b, and test article instrumentation 186. The controller 140 can also be coupled to a fatigue tester 150, described later with reference to FIGS. 7A-7B. The controller 140 can include a processor 141, a memory 142, and/or other features (e.g., input/output features) typical of standard computer operated controllers. The controller 140 can be specifically programmed with computer-operable instructions to control the activation of the first and second winches 125a, 125b. Accordingly, for example, the controller 140 can be programmed with instructions to coordinate the actions of the first and second winches 125a, 125b to avoid subjecting the test article to unbalanced loads. The controller 140 can also receive data from the instrumentation 186 carried by the test article. The controller 140 can process, pre-process, post-process and/or provide other operations in association with these data. For example, the controller 140 can be programmed to record fatigue loads on the test article 180 (FIG. 1), which generally exhibit a sinusoidal wave pattern having a generally unvarying amplitude when the applied load amplitude is unvarying. The controller 140 can respond to signals from the instrumentation 186 that deviate from this pattern by identifying a test article failure, imminent failure, or testing anomaly. The controller 140 can be coupled to the various system elements with two-way communications links so as to both send and receive data. The links between the controller 140 and the system components can be wireless or wired links depending upon the particular application in which the controller 140 is used.

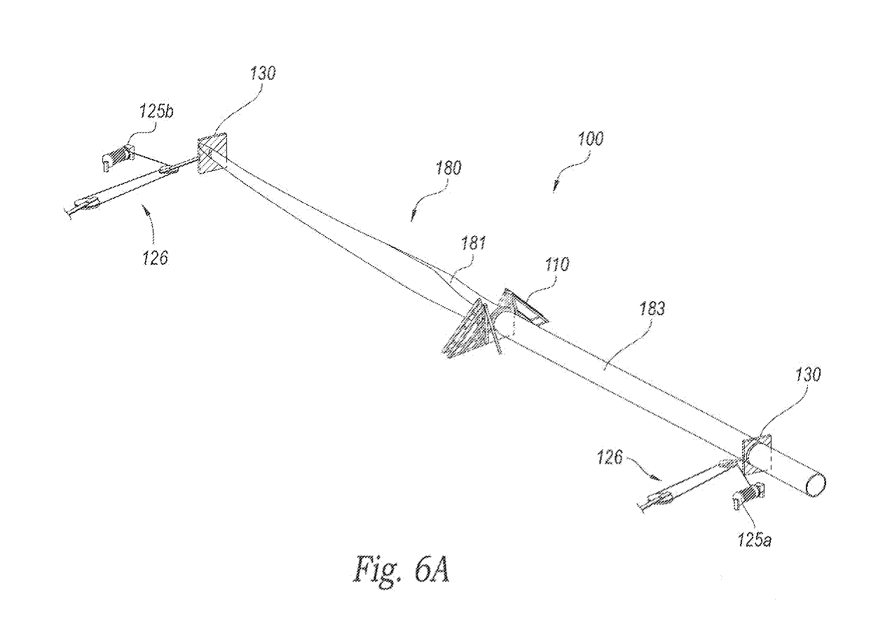

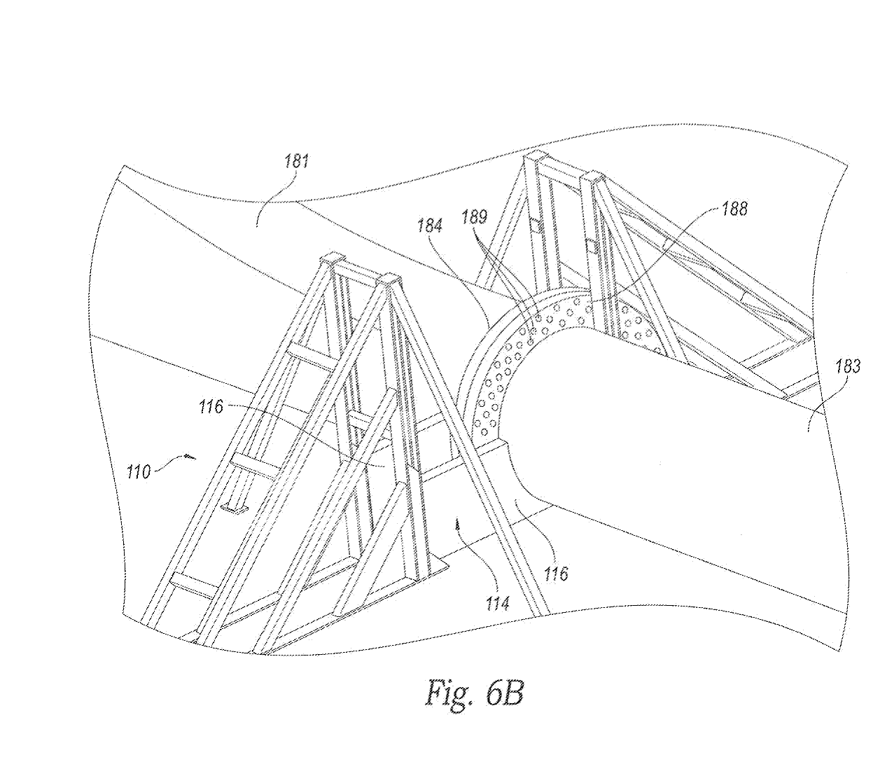

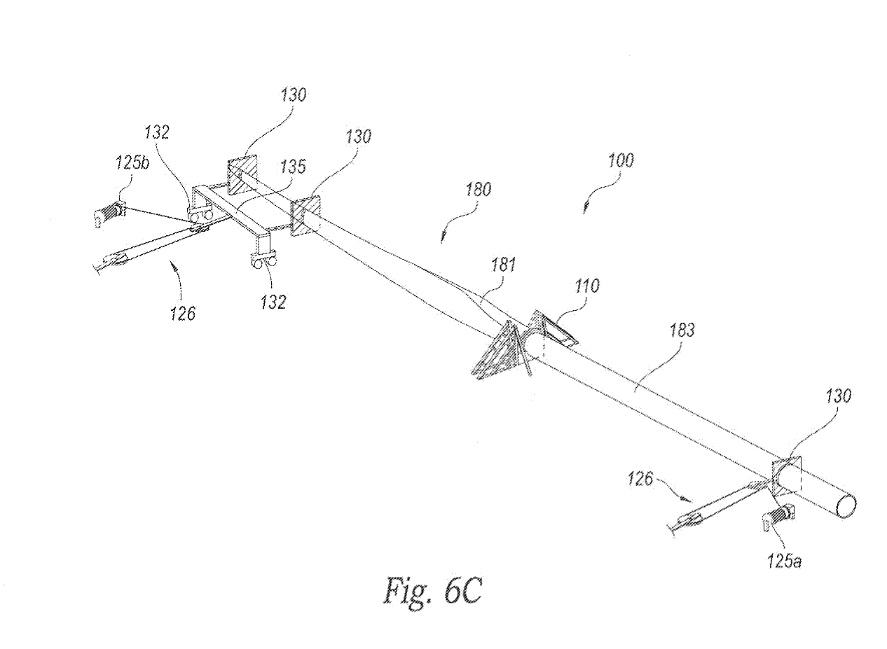

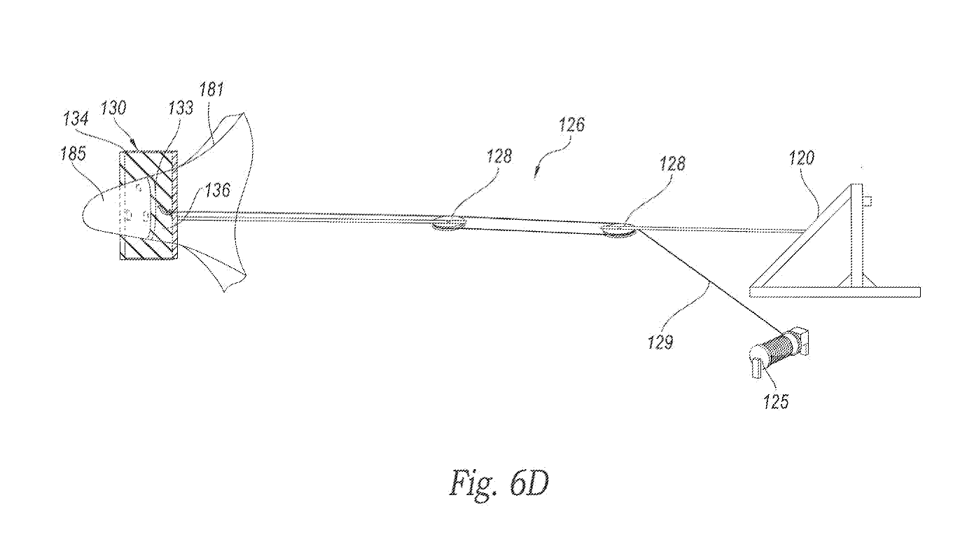

FIG. 6A is a partially schematic, isometric illustration of an embodiment of the test system 100, illustrating features for providing attachments to the test article 180, in this case, the wind turbine blade 181. In a particular aspect of this embodiment, the test system 100 can include a series of frames that are attached to the test article 180 and that provide an interface between the test article 180 and the structures of the test system 100. For example, the test system 100 can include a stand frame 114 that provides an interface between the wind turbine blade 181 (e.g., the blade hub) and the test stand 110. The system 100 can further include anchor frames 130 that provide an interface between the wind turbine blade 181 and the extender 183 on one hand, and the corresponding pulley arrangements 126, winches 125a, 125b and reaction anchors 120 on the other. For purposes of illustration, the associated reaction anchors 120 are not shown in FIG. 6A.

FIG. 6B is an enlarged, isometric illustration of the test stand 110, illustrating the stand frame 114 located at the interface between the extender 183 and the wind turbine blade 181. The extender 183 can be attached to the wind turbine blade 181 using an existing hub attachment feature of the blade 181, e.g., a blade flange 184 carried by the blade 181. The extender 183 can include a corresponding extender flange 188 having multiple concentric bolt circles 189 (three are shown in FIG. 6B) or other attachment features that allow the extender 183 to be used with wind turbine blades having different hubs. The extender flange 188 is attached to the blade flange 184 with bolts. The stand frame 114 can include two spaced-apart frame flanges 116 that capture the blade flange 184 and the extender flange 188 between them. In other embodiments, the extender 183 can be attached to the blade 181, and/or can interface with the test stand 110 using other arrangements that allow the overall test configuration to be rapidly changed to suit different test plans, test loads, and/or blade shapes and sizes.

FIG. 6C is a partially schematic, isometric illustration of an embodiment of the test system 100, configured to apply a load simultaneously at multiple points along the length of the wind turbine blade 181 or other test article 180. In one aspect of this embodiment, a single second winch 125b is coupled to multiple anchor frames 130 via a pulley arrangement 126 and a spreader bar 135. The spreader bar 135 can be supported by dollies 132 that roll with the bar 135 as it moves under the force provided by the second winch 125b. A similar arrangement can be used to apply loads at other points along the length of the blade 181. In other embodiments, multiple winches or other arrangements can be used to independently control the loads applied at various points along the length of the blade 181.

FIG. 6D is a partially schematic illustration of the tip region 185 of the wind turbine blade 181 and the associated anchor frame 130. The anchor frame 130 can include a flange 134 surrounding a web 136. The web 136 can include an aperture 133 which is sized to receive the wind turbine blade 181. The anchor frame 130 is connected to the cable 129, which is in turn connected to the winch 125 via the pulley arrangement 126. The pulleys 128 can be connected directly to the anchor frame 130, the anchor 120, and/or to other structures.

FIG. 7A is a partially schematic, isometric illustration of an anchor frame 130 described above with reference to FIG. 6A. As shown in FIG. 7A, the aperture 133 in the anchor frame 130 is sized to receive the wind turbine blade 181. Accordingly, different anchor frames 130 may be used for different wind turbine blades and/or at different points along the length of a particular wind turbine blade 181 to accommodate the spatially varying cross-sectional shape of the wind turbine blade 181. In a particular embodiment, the anchor frame 130 is attached to the wind turbine blade 181 to prevent the anchor frame 130 from moving relative to the wind turbine blade 181 during testing. In an embodiment shown in FIG. 7A, the wind turbine blade 181 includes three longitudinally extending spars 187, and the anchor frame 130 can be attached directly to the spars 187 via fasteners that pass through an external skin of the wind turbine blade 181 and into the spars 187. In other embodiments, the anchor frame 130 can be attached to wind turbine blades having other internal and/or external structures. Representative structures include, but are not limited to, those disclosed in pending PCT Application No. US09/66,875, filed on Dec. 4, 2009, incorporated herein in its entirety by reference. The frame 130 can include one or more load holes 135 positioned to receive an actuator coupling for loading the wind turbine blade 181. The load holes 135 can be positioned to allow testing along multiple axes, as was described above with reference to FIG. 4.

In a particular embodiment, the anchor frame 130 can be coupled to the winch 125 via the cable 129 described above with reference to FIG. 6D. In another embodiment, the frame 130 can be coupled to a fatigue tester 150 for fatigue loading. In a particular aspect of this embodiment, the fatigue tester 150 can include a motor 151 coupled to a motor shaft 152 which drives a flywheel 153. The flywheel 153 carries an eccentric pin 154 to which a connector 155 is attached. The connector 155 is then attached to the frame 130 via the load hole 135. In a particular aspect of this embodiment, the connector 155 can be a cable and in another embodiment, the connector 155 can be a rigid arm.

In other embodiments, the fatigue tester 150 can have other arrangements. For example, in an embodiment shown in FIG. 7B, the fatigue tester 150 can include one or more hydraulic actuators 156 that are connected to the anchor frame 130 via corresponding connectors 155. A pump 157 provides hydraulic power to the hydraulic actuators 156. In other embodiments, the fatigue tester 150 can include still further arrangements, and/or can be attached to the test article 180 via arrangements other than the anchor frame 130 described above.

From the foregoing, it will be appreciated that specific embodiments of the technology have been described herein for purposes of illustration, but that various modifications may be made without deviating from the technology. For example, while specific embodiments described above include two reaction anchors, each of which provides a load to the test article at a corresponding location, in other embodiments, the system can include more than two reaction anchors and associated winches or other active devices to provide a more finely graduated loading along the length of the wind turbine blade or other test article. In a particular embodiment described above, the reaction anchors are easily reconfigurable because they include water tanks which can easily be emptied and refilled after the corresponding sled has been repositioned. In other embodiments, other liquids can be used to provide the same function. In still further embodiments, readily available solids (e.g., sand) can also be used to provide a similar function, or releasable fixtures can temporarily attach the sleds to the base.

Certain aspects of the disclosure described in the context of particular embodiments may be combined or eliminated in other embodiments. For example, the fatigue loading arrangements described above with reference to FIGS. 7A-7B can be applied to the blade segment test article described with reference to FIG. 1. In such an embodiment, the anchor frame can be eliminated, and the fatigue tester can be coupled directly to the first and/or second extender. Further, while advantages associated with certain embodiments have been described in the context of those embodiments, other embodiments may also exhibit such advantages, and not all embodiments need necessarily exhibit such advantages to fall within the scope of the present disclosure. Accordingly, the present disclosure can encompass other embodiments not expressly shown or described herein.

I/We claim:

1. A system for testing wind turbine blades, comprising:
a test stand positioned to carry a test article that includes at least a portion of a wind turbine blade;
a first reaction anchor movably positioned relative to the test stand;
a second reaction anchor movably positioned relative to the test stand;
a first generally horizontal force link attached to the first reaction anchor and coupleable to the test article to apply a first horizontal load to the test article; and
a second generally horizontal force link attached to the second reaction anchor and coupleable to the test article to apply a second horizontal load to the test article, wherein the test stand is positioned to apply a test stand force to the test article equal and opposite to the sum of the first and second horizontal loads.

2. The system of claim 1, further comprising an extender removably coupled to one of the first and second force links and coupleable to an end of the test article.

3. The system of claim 2 wherein the extender includes multiple attachment features positioned to releasably connect it to wind turbine blades having different geometries.

4. The system of claim 1 wherein the first force link includes a cable connected to an actuator, and wherein the cable is coupled to the first reaction anchor to transmit the first horizontal load to the first reaction anchor.

5. The system of claim 1, further comprising a test pad, and wherein the test stand is fixedly mounted to the test pad, and wherein each of the first and second reaction anchors are movable relative to the test pad.

6. The system of claim 1 wherein at least one of the first and second reaction anchors includes a water vessel that is changeable between a first state in which the water vessel contains a first amount of water sufficient to cause the at least one reaction anchor to remain stationary while a corresponding one of the first and second horizontal loads is applied to the at least one reaction anchor, and a second state in which the water vessel contains no water or second amount of water less than the first to allow the at least one reaction anchor to be moved.

7. The system of claim 1, wherein the extender includes a flange having a bolt pattern positioned to align with a corresponding bolt pattern of the test article.

8. The system of claim 1, further comprising the test article.

9. The system of claim 8 wherein the test article includes a portion of a wind turbine blade.

10. The system of claim 8 wherein the test article includes a full-scale wind turbine blade.

11. A system for testing wind turbine blades, comprising:
a test stand;
a full-scale wind turbine blade carried by the test stand, the wind turbine blade having a hub region and a tip region;
a hub extender removably connected to the hub region of the wind turbine blade and extending outwardly from the hub region and away from the tip region;
a first reaction anchor movably positioned relative to the test stand;
a second reaction anchor movably positioned relative to the test stand, wherein each of the first and second reaction anchors includes a movable sled and a refillable water tank;
a first generally horizontal force link attached to the first reaction anchor and the hub extender to apply a first horizontal load to the wind turbine blade in a first direction, the first force link including first cable threaded through a first pulley arrangement and connected to a first winch; and
a second generally horizontal force link attached to the second reaction anchor and the tip region of the wind turbine blade to apply a second horizontal load to the wind turbine blade in the first direction, the second force link including second cable threaded through a second pulley arrangement and connected to a second winch, wherein the test stand is positioned to apply a horizontal test stand force to the wind turbine blade equal to the sum of the first and second horizontal forces and in a second direction opposite the first direction.

12. The system of claim 11, further comprising a test pad, and wherein the test stand is fixedly attached to the test pad.

13. A method for testing wind turbine blades, comprising:
carrying a test article at a test stand, the test article including at least a portion of a wind turbine blade;
positioning a first reaction anchor relative to the test stand;
positioning a second reaction anchor relative to the test stand;
applying a first horizontal load to a first portion the test article;
applying a second horizontal load to a second portion the test article; and
applying a test stand force to the test article at the test stand, the test stand force being equal and opposite to the sum of the first and second horizontal loads.

14. The method of claim 13 wherein carrying at least a portion of a wind turbine blade includes carrying a full scale wind turbine blade.

15. The method of claim 14 wherein the wind turbine blade includes a hub region and a tip region, and wherein the method further comprises attaching a hub extender to the hub region with the hub extender extending axially away from the hub region in a direction generally opposite the tip region, further wherein:
applying the first horizontal load includes applying the first horizontal load to the tip region in a first direction;
applying the second horizontal load includes applying the second horizontal load to the hub extender in the first direction; and
applying the test stand force includes applying the test stand force in a second direction opposite the first direction.

16. The method of claim 13 wherein applying the first horizontal load and the second horizontal load includes applying the first and second horizontal loads while the test article has a first orientation, and wherein applying the test stand force includes applying a first test stand force, and wherein the method further comprises:
rotating the test article from the first orientation to a second orientation about a rotation axis generally aligned with a longitudinal axis of the test article;
applying a third horizontal load to the first portion the test article;
applying a fourth horizontal load to a second portion the test article; and
applying a second test stand force to the test article at the test stand, the second test stand force being equal and opposite to the sum of the third and fourth horizontal loads.

17. The method of claim 13 wherein the test article is a first test article that includes at least a portion of a first wind turbine blade having a first size and a first shape, and wherein the method further comprises:
removing the first test article from the test stand;
carrying a second test article at the test stand, the second test article including at least a portion of a second wind turbine blade having a second size and a second shape, with at least one of (a) the second size being different than the first size, and (b) the second shape being different than the first shape;
repositioning at least one of the first and second reaction anchors relative to the test stand to accommodate the second wind turbine blade;
applying a third horizontal load to a first portion the second test article;
applying a fourth horizontal load to a second portion the second test article; and
applying another test stand force to the second test article at the test stand, the other test stand force being equal and opposite to the sum of the third and fourth horizontal loads.

18. The method of claim 17, further comprising:
releasably attaching a hub extender to the first wind turbine blade, and wherein applying the second horizontal load includes applying the second horizontal load to the hub extender;
removing the hub extender from the first wind turbine blade;
releasably attaching the hub extender to the second wind turbine blade, and wherein applying the fourth horizontal load includes applying the fourth horizontal load to the hub extender attached to the second wind turbine blade.

19. The method of claim 17 wherein repositioning at least one of the first and second reaction anchors relative to the test stand includes:
removing water from a tank carried by the at least one reaction anchor;
moving the at least one reaction anchor relative to the test stand; and
adding water to the tank carried by the at least one reaction anchor.

20. The method of claim 13 wherein at least one of applying the first load and applying the second load includes applying the at least one load via a winch.

21. The method of claim 13 wherein the test article is elongated along a longitudinal axis, wherein applying the first and second loads includes applying the first and second loads from a first side of the longitudinal axis, wherein applying a test stand force includes applying a first test stand force from the first side of the longitudinal axis, and wherein the method further comprises:
moving the first reaction anchor to a second side of the longitudinal axis opposite the first side;
moving the first reaction anchor to the second side of the longitudinal axis;
applying a third horizontal load to the first portion the test article from the second side of the longitudinal axis;
applying a fourth horizontal load to the second portion the test article from the second side of the longitudinal axis; and
applying a second test stand force to the test article at the test stand, the second test stand force being equal and opposite to the sum of the third and fourth horizontal loads.

22. The method of claim 13 wherein applying the first and the second loads includes applying first and second fatigue loads.

23. The method of claim 22, further comprising automatically detecting a change in response to the fatigue loads and signaling a failure of the test article.

24. The method of claim 13, further comprising releasably attaching a frame to the test article, and wherein applying the first horizontal load includes applying the first horizontal load via a load path that includes the frame.

25. A method for testing wind turbine blades, comprising:
carrying a full-scale wind turbine blade at a test stand, the wind turbine blade having a hub region and a tip region;
releasably attaching a hub extender to the hub region of the wind turbine blade so as to extend outwardly from the hub region away from the tip region;
moving a first reaction anchor into position relative to the test stand;
moving a second reaction anchor into position relative to the test stand;
releasably securing the first and second reaction anchors relative to the test stand by placing water in individual refillable tanks carried by the each of the first and second reaction anchors;
coupling a first cable to the hub extender, threading the first cable through a first pulley arrangement attached to the first reaction anchor, and coupling the first cable to a first winch;
coupling a second cable to the tip region, threading the second cable through a second pulley arrangement attached to the second reaction anchor, and coupling the second cable to a second winch;
activating the first winch to apply a first generally horizontal load to the hub extender in a first direction;
activating the second winch to apply a second generally horizontal load to the tip region in the first direction; and
applying a horizontal test stand force to the wind turbine blade and the hub extender via the test stand, the test stand force being equal to the sum of the first and second horizontal loads and being directed in a second direction opposite the first direction.

26. The method of claim 25 wherein the wind turbine blade is a first wind turbine blade, and wherein the method further comprises:
removing the hub extender from the first wind turbine blade;
releasably attaching the hub extender to a second wind turbine blade having a size different than that of the first wind turbine blade; and
testing the second wind turbine blade by applying a load to the second wind turbine blade via the hub extender.
